(19) United States
(12) Patent Application Publication
(10) Pub. No.: US 2014/0323929 A1
(43) Pub. Date: Oct. 30, 2014

(54) TRAINER G-VIBE

(71) Applicant: Ievgen Valeriyovych Iurchenko, Pereiaslivske (UA)

(72) Inventor: Ievgen Valeriyovych Iurchenko, Pereiaslivske (UA)

(21) Appl. No.: 14/263,755

(22) Filed: Apr. 28, 2014

Related U.S. Application Data
(60) Provisional application No. 61/817,437, filed on Apr. 30, 2013.

(51) Int. Cl. A61H 19/00

(52) U.S. Cl. CPC A61H 19/40
USPC 601/46

(57) ABSTRACT

The invention refers to trainers for human pelvic muscle. The trainer G-vibe is a V-like device in the form of two oblong elements elastically united together by one end with the formation of a convex main part, where the oblong elements are flexible and the main part formed by them is a working part and is directly a massager.

The device is a multifunctional, easy in usage and comfortable to hold during doing exercises and allows simultaneous training of woman's pelvic muscles which surround the vaginal canal, and stimulation of sensitive spots and walls of the anal sphincter.

The invention refers to trainers for human pelvic muscles, in particular for training woman's muscles that surround vaginal canal and for stimulation of sensitive spots and walls of anal sphincter.

Such trainers are used for development and strengthening of anal and vaginal muscles, for transference of intimate muscles into the category of controllable. Such devices can be used in medicine, and the trainings improve health, develop sexual capabilities.

A known trainer (U.S. Pat. No. 5,865,715) which is a V-like element in the form of two oblong plates united together on the one end by a hinge. The other two ends of these plates are loose, and these ends are inserted into vagina. Pressure springs are installed between the plates. A user squeezes the plates by pelvic muscles overcoming the resistance of springs. A drawback of this device is the absence of feedback, i.e. a user does not feel how tightly he has squeezed the trainer.

A known trainer (U.S. Pat. No. 6,733,425) which is a V-like element in the form of two oblong plates united together on the one end by a hinge. The other two ends of these plates are loose, and these ends are inserted into vagina. Pressure springs are installed between the plates. A user squeezes the plates by pelvic muscles overcoming the resistance of springs. A corrugated air chamber is also installed between the plates; the chamber is united with a manometer with the help of a tube. According to the indices of manometer a user observes how tightly he has squeezed the trainer. A drawback of a given device is the complexity of the design as well as the complexity of feedback—transformation of mechanics (motion of the plates) into pneumatics (compression of air) and again into mechanics (motion of a manometer's indicator). Errors in measurement arise on this way.

A known trainer (U.S. Pat. No. 6,224,525) which is a V-like device in the form of two oblong elements elastically united together by one end with the formation of a convex main part which is inserted into vagina. The other two ends are loose and spread apart. A user squeezes the oblong elements overcoming their elastic joint. A drawback of this device is the complete absence of feedback, i.e. a user does not feel how tightly he has squeezed the trainer.

A known trainer (UA 96543 C2) which is the most similar to the one that is being declared according to its technical essence and taken as a prototype which is a V-like device in the form of two oblong elements elastically united together by one end with the formation of a convex main part; besides that, a magnetic reed switch is installed on the one of the oblong elements, and a magnet is installed on the other oblong element. Magnetic reed switch(es) and a magnet are united with the source of power supply and means of indication. The oblong elements are united together by a hinge, and a flat spring is installed in the convex main part.

A lack of this device is a narrow functionality of the design, its complexity, uncomfortable holding of the trainer in the process of doing exercises as well as the fact that known device is not designed for simultaneous training of vagina and stimulation of anal sphincter.

The invention is based on the aim to develop a multifunctional trainer, simple in usage, with comfortable holding during doing the exercises, with the possibility of simultaneous training of woman's pelvic muscles that surround vaginal canal, and stimulation of sensitive spots and walls of anal sphincter.

The aim which the declared invention is based on is solved by the way that the trainer G-vibe is a V-like device in the form of two oblong elements elastically united together by one end with the formation of a convex main part; according to the invention the oblong elements are flexible, and the main part formed by them is a working part and is directly a massager. The aim is also solved in the way that the motors with various versions of vibration are located on the tips of oblong elements; at the same time there may be from one to six versions of vibration that are united with the source of power supply (accumulator) with the help of a wire which extends from the tips of oblong elements to the base of the main part, where the base is a handle of the device and is a ring of an oval shape with a through hole; wherein the end of the massage part and the passage to the base is separated by a special laid on ring. Besides that a control panel is built in the handle of the device, where the control buttons are located on the lateral side, below which a hole for charging the device with the help of the USB charging cord is located. In addition, the light indicators as means of indication are placed on the handle of the device between the control buttons; they shine at switching on/off the device and changing vibration modes.

The device has an ergonomic shape and a total length of 240 mm. The trainer G-vibe is a V-like device in the form of two oblong elements with flexible tips elastically united together by one end with the formation of a convex main part where the main part formed by them is a working part and is directly a massager. The diameter of the massage part is 35 mm and its total length is 165 mm; wherein the oblong elements to the point where they are united have the length of 82 mm. The tips of the trainer are connected at the insertion into vagina or anal sphincter and disperse inside. This creates sensation of fullness without stretching the entrance. The device is placed inside the body with maximum comfort and effectively trains and stimulates the most sensitive spots. The tips have a fixed squeezing degree, specially designed with the consideration of the human anatomy. Quiet but very powerful motors are located inside two oblong elements, or in their tips to be more precise; these motors have the shape of cylinders with the length of 20 mm and height of 11 mm with various versions of vibration; moreover, there may be from one to six versions of vibration. It is possible to change intensity in every vibration mode—from light tremors to intense vibration. The motors are united with the source of power supply with the help of a wire inside the tips, that extends from the end of the oblong elements to the base of the main part which is the handle of the device and is a ring of an oval shape with a through hole; wherein the end of the massage part and the passage to the base is separated by a special laid on ring. The source of power supply (accumulator) itself is located in the end of the massage part in the ring.

The control panel is built in a comfortable ergonomic handle of the device made of the same material as the working part of the trainer. This eliminates sliding of the trainer in the hand, even if a lubricant is used, and this also helps to turn on/off the device quickly and easily as well as adjust an optimal vibration mode. The control buttons are located on the lateral side of the handle, wherein every button is located one above the other in the following order from top to bottom—the button of switching off the device, changing vibration modes and the button of switching on the device. As means of indication, the trainer G-vibe has two light indicators, located above and below the button of changing vibration modes; the light indicators shine at switching on/off the device and changing vibration modes. The hole for easy charging of the device with the help of the USB charging cord is located below the control buttons.

The device is made using the material of premium class—high quality, ecologically safe, hypoallergenic medical material—silicone. Due to the flexibility of silicone, the design adapts to every person individually; wherein the width of the entrance does not matter, as what is important is the width of the opening itself.

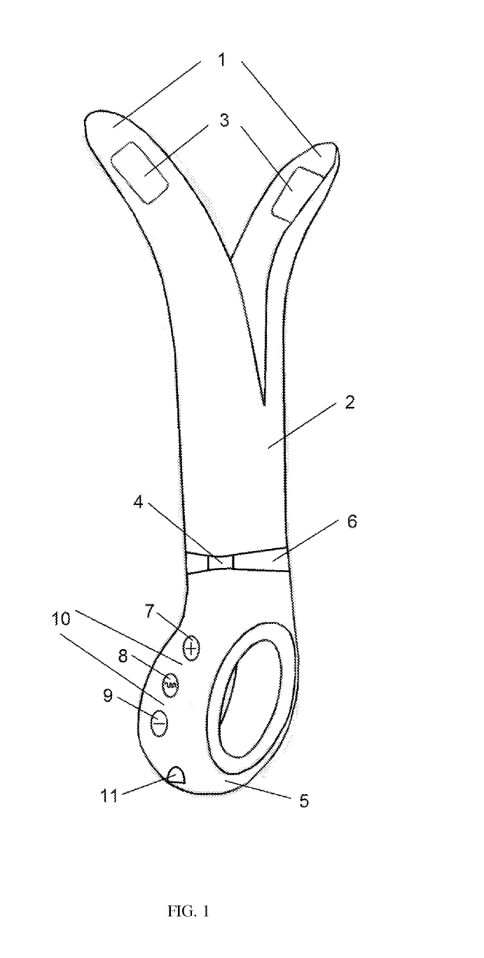

FIG. 1 shows the general view of the trainer G-vibe,

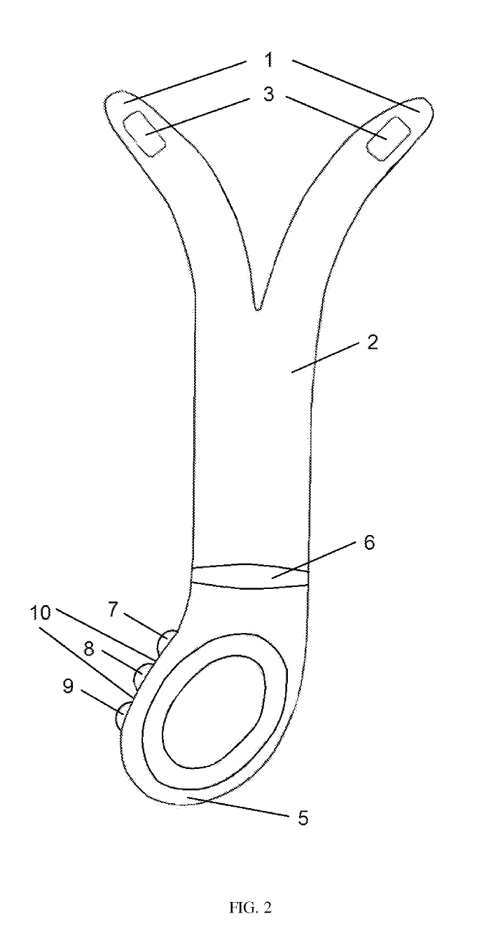

FIG. 2 shows the front view of the product,

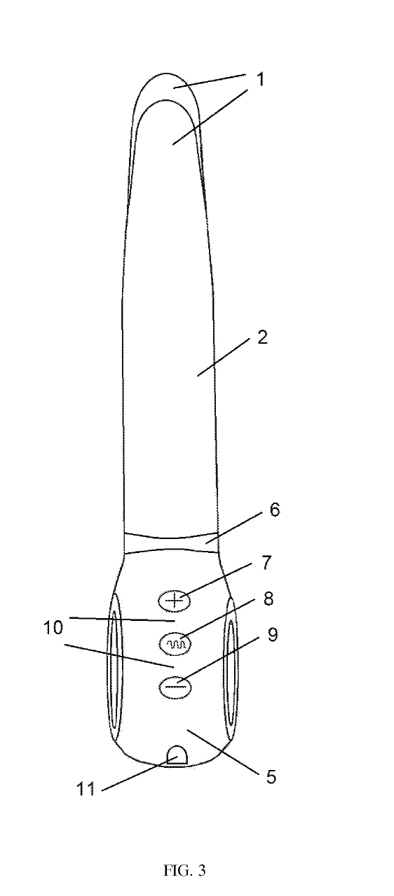

FIG. 3 shows the lateral view of the product indicating the control buttons of the device.

The trainer G-vibe is a device of a V-like shape in the form of two oblong flexible elements 1, elastically united together by one oblong end with the formation of the main part which is the massage part 2. Quiet but very powerful motors 3 are located inside the two oblong elements 1, to be more precise, in their tips, with six versions of vibration. Motors 3 are united with the source of power supply (accumulator) 4 with the help of a wire inside the tips, that extends from the end of the oblong elements to the base of the main part where the base is a handle 5 and is a ring of an oval shape with a through hole; wherein, the end of the massage part and the passage to the base is separated by a special laid on ring 6. The source of power supply (accumulator) itself 5 is located in the end of the massage part in the ring 6.

The control panel is built in the handle of the device 5; buttons of switching on the device 7, changing vibration modes 8 and switching off the device 9 are located on the lateral part of the handle. Two light indicators 10 are located above and below the button of changing vibration modes 8 inside the trainer; the light indicators are switched on when using the buttons of switching on the device 7, changing vibration modes 8 and switching off the device 9. The hole 11 for easy charging of the device with the help of the USB charging cord is located below the control buttons.

When using the trainer, holding the handle of the product 5, the oblong elements 1 are inserted into vagina or anus. The tips of the trainer are connected at the insertion into vagina or anal sphincter and disperse inside. Switching on the device with the help of the button 7 and switching on the lateral side of the handle of the product 5 the button of changing vibration modes and intensity of squeezing 8, due to the motors 3, built in oblong elements 1, training and stimulation of certain parts of the human body is achieved.

Thus, the advantages according to the invention are multifunctionality of the device, its simplicity in usage and comfort of holding during doing exercises with the help of the ergonomic handle which is located in the base of the trainer.

The trainer G-vibe is designed with consideration of the human anatomy, with the help of which it is possible to train and stimulate simultaneously woman's pelvic muscles which surround the vaginal canal and anal sphincter. Due to the device has two tips that are connected at the insertion into vagina or anal sphincter and disperse inside, thus training and stimulating simultaneously the walls of vagina and/or anus, a user has sensation of fullness without stretching the entrance. The device is placed inside the body with maximum comfort and effectively trains and stimulates the most sensitive spots. This cannot be achieved with the help of other trainers since already known similar designs have only one tip. Moreover, it is also possible to train and stimulate simultaneously not only one wall of vagina or anus, but the opposite sides, so that all muscles and not their certain part will strain themselves and give way to training.

1. The trainer G-vibe is a V-like device in the form of two oblong elements elastically united together by one end with the formation of a convex main part, characterized in that the oblong elements are flexible and the main part formed by them is a working part and is directly a massager.

2. The trainer G-vibe according to claim 1, characterized in that the motors with various versions of vibration are located on the tips of the oblong elements.

3. The trainer G-vibe according to claim 2, characterized in that there may be from one to six versions of vibration of motors.

4. The trainer G-vibe according to any of the claim 2 or 3, characterized in that the motors are connected with the source of power supply (accumulator) with the help of a wire which extends from the end of the oblong elements to the base of the main part.

5. The trainer G-vibe according to claim 1, characterized in that the base of the main part is a handle of the product and is a ring of an oval shape with a through hole, wherein the end of the massage part and the passage to the base is separated by a special laid on ring.

6. The trainer G-vibe according to any of the claim 1 or 5, characterized in that the control panel is built in the handle of the product, where the control buttons are located on the lateral side of the handle.

7. The trainer G-vibe according to claim 6, characterized in that the hole for charging the product with the help of a USB charging cord is located below the buttons of control panel.

8. The trainer G-vibe according to any of the claim 1, 5 or 6, characterized in that the light indicators as means of indication are located on the handle of the product between the control buttons, wherein the light indicators shine at switching on/off the product and changing vibration modes.
